(19) United States
(12) Patent Application Publication
(10) Pub. No.: US 2025/0259508 A1
(43) Pub. Date: Aug. 14, 2025

(54) CROSS-PLATFORM FEATURE SYNCHING

(71) Applicant: Primero Games, LLC, Norcross, GA (US)

(72) Inventors: Michael M. Macke, Duluth, GA (US); Barry W. Rutherford, Duluth, GA (US); Mark C. Nizdil, Duluth, GA (US)

(21) Appl. No.: 18/437,579

(22) Filed: Feb. 9, 2024

(51) Int. Cl. G07F 17/32

(52) U.S. Cl. CPC G07F 17/3237; G07F 17/3227; G07F 17/3248; G07F 17/3258; G07F 17/3269

(57) ABSTRACT

The gaming system can receive a request to enable a first gaming feature for a particular wagering game on a gaming device. The wagering game can be a first type of wagering game and the request can be associated with a first patron account. The gaming system can process a transaction to enable the first gaming feature for the first patron account. The gaming system can determine that a second gaming feature for a second type of wagering game corresponds to the first gaming feature. The gaming system can establish communication with the second gaming system and transmit a request to enable the second gaming feature. The second gaming system can enable the gaming feature. After determining that a predetermined period of time has elapsed, the first gaming system or the second gaming system can disable the first gaming feature or the second gaming feature.

### TECHNICAL FIELD

The present systems and processes relate to utilizing computing technology to provide feature synching across multiple various gaming platform technologies.

### BACKGROUND

Wagering games can offer additional gaming features for purchase or redemption by patrons or users. Gaming features can include, but are not limited to, bonus games, wild symbols, progressive jackpots, and game designs. Gaming features can improve the experience playing a wagering game and encourage patrons to continue playing wagering games. Patrons may have user or patron accounts across different gaming technology platforms including land based, mobile, remote gaming servers, lottery, and social gaming, among other platforms. The gaming features do not synch across these various gaming platforms, which can discourage patrons from purchasing or redeeming such gaming features. Therefore, there is a long-felt but unresolved need for gaming technology to synch gaming features across different gaming platforms.

### BRIEF SUMMARY OF THE DISCLOSURE

Aspects of the present disclosure generally relate to synching gaming features across different gaming platforms. The gaming platforms can span various technology, such as brick and mortar slot machines, Facebook applications, lottery systems, mobile applications, remote gaming servers (RGS), video games including esport platforms, and sports betting platforms, among other platforms. While similar features may exist on the various platforms, the systems operate independently and use different disparate math models for deploying the gaming features within the game.

A gaming platform can generate outcomes for a wagering game and can increase or decrease the credits or tokens associated with the wagering game. The gaming platform can prompt the patron or user or receive a request from the patron or user to purchase or redeem a gaming feature. The gaming feature can include, a set of graphics, a wild symbol, a bonus game, a payback feature, an upgraded pay table, nudging attempts, a visual skin, a game of skill, assigning the wagering game to a particular level of a progressive jackpot, eligibility to win a progressive jackpot, and a previously-unavailable game.

The gaming platform can process a transaction to enable the gaming feature for use in the wagering game on the particular gaming platform. The gaming platform can process the transaction using the credits or tokens associated with the gaming platform. The gaming platform can convert credits or tokens associated with a different gaming platform onto the gaming platform. The converted credits can be used for the transaction. The gaming platform can authenticate credentials for a user or patron account associated with the respective gaming platform and can link that account to a different user or patron account for a different gaming platform. In some embodiments, the same user or patron account can be used across multiple gaming platforms. For example, a casino management system may offer user or patron accounts for use on gaming devices and a mobile gaming platform. After processing the transaction, the gaming platform can enable the gaming feature for the user or patron account. The user or patron account can correspond to a federated identity provider, which can be accepted or used by different gaming platforms.

The gaming platform can determine that the enabled gaming feature corresponds to a gaming feature on a different gaming platform. For example, the gaming platform can include a gaming device and the enabled gaming feature can include a bonus game. In this example, the gaming device can determine that the enabled bonus game corresponds with a bonus game or a different gaming feature on a mobile gaming platform, a social gaming platform, or an online gaming platform. After determining that the enabled gaming feature corresponds to a gaming feature on a different gaming platform, the two or more gaming platforms can establish communication and exchange requests to enable the corresponding gaming features. In some embodiments, the gaming features can include predetermined time limits or predetermined number of wagering games before the gaming features are disabled.

The above and further features of the disclosed systems and methods will be recognized from the following detailed descriptions and drawings of various embodiments.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1A illustrates an exemplary cross-platform synching system according to various embodiments of the present disclosure.

FIG. 1B illustrates an exemplary cross-platform synching system according to various embodiments of the present disclosure.

FIG. 2 illustrates an exemplary networked environment according to various embodiments of the present disclosure.

FIG. 3 illustrates an exemplary overall process for the disclosed system according to various embodiments of the present disclosure.

FIG. 4 illustrates playing a wagering game according to various embodiments of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### EXEMPLARY EMBODIMENTS

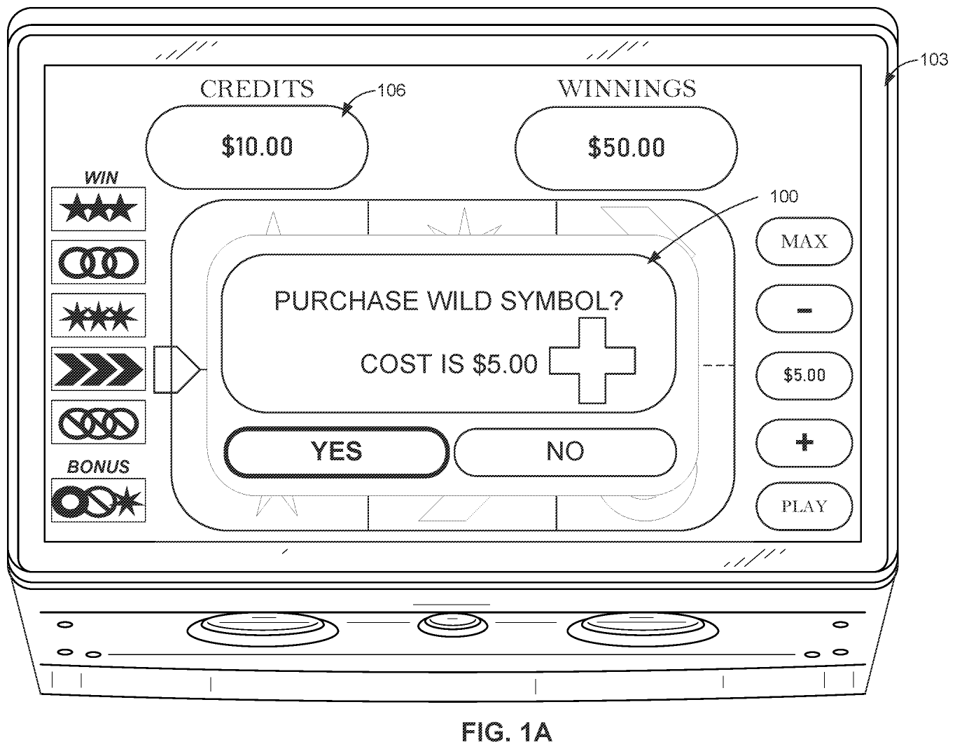

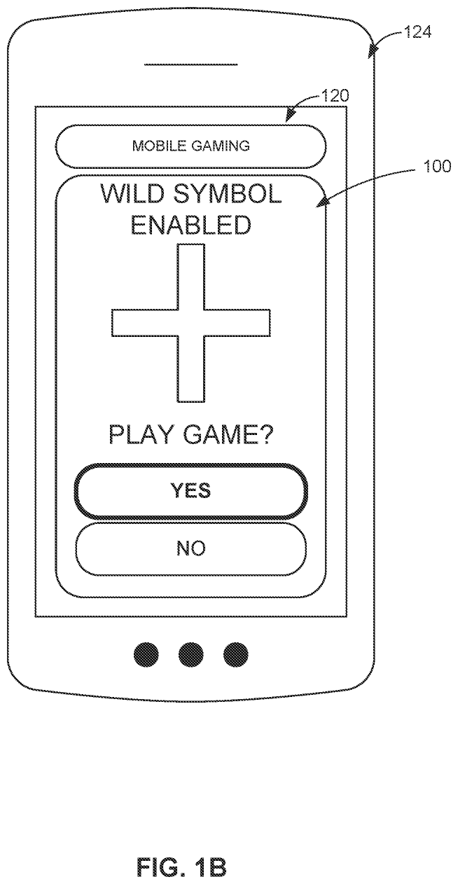

Referring now to the figures, for the purposes of example and explanation of the fundamental processes and components of the disclosed systems and processes, reference is made to FIG. 1A, which illustrates the cross-platform synching system 100. The cross-platform synching system 100 can prompt a user or patron playing a wagering game on the gaming device 103 to purchase a gaming feature. The gaming features can include, but are not limited to, a set of graphics, a wild symbol, a bonus game, a payback feature, an upgraded pay table, nudging attempts, a visual skin, a game of skill, assigning the wagering game to a particular level of a progressive jackpot, eligibility to win a progressive jackpot, and a previously-unavailable game. For example, the cross-platform synching system 100 shown in FIG. 1A can prompt the user or patron to purchase one or more wild symbols. If the user or patron agrees to purchase the wild symbol, the cross-platform synching system 100 can process the transaction to purchase the wild symbol. In some embodiments, the user or patron can request to purchase a gaming feature without the cross-platform synching system 100 prompting the user or patron.

The cross-platform synching system 100 can process the transaction to enable the gaming feature using the credits 106 associated with the patron or user account. After processing the transaction and enabling the gaming feature, the cross-platform synching system 100 can determine if the enabled gaming feature corresponds with a second gaming feature on a second gaming platform for playing a second wagering game. In some embodiments, the cross-platform synching system 100 can determine if the gaming feature corresponds to a second gaming feature on a second gaming platform before processing the transaction. In one embodiment, the cross-platform synching system 100 can determine a cost function to determine a cost for the gaming feature based on a cost of the current platform gaming feature and the costs of any corresponding game features on other platforms.

The second gaming platform can include, but is not limited to, a casino gaming platform, a mobile gaming platform, a social gaming platform, and an online gaming platform. If the cross-platform synching system 100 determines that particular gaming feature corresponds to a second gaming feature on a second gaming platform, the cross-platform synching system 100 can enable the second gaming feature on the second gaming platform as part of the transaction. The cross-platform synching system 100 can authenticate the user or patron account of the user or patron playing the wagering game on the gaming device 103. The cross-platform synching system 100 can pair or link two or more user accounts across two or more gaming platforms. After authenticating the user or patron account, the cross-platform synching system 100 can enable the second gaming feature for the user or patron account corresponding to the second gaming platform. In some embodiments, the cross-platform synching system 100 can also enable one or additional gaming feature on one or more additional gaming platform beyond the second gaming feature.

Referring now to FIG. 1B, shown is the cross-platform synching system 100 on the mobile gaming platform 120 on the mobile device 124. After determining that the gaming feature on the gaming device 103 corresponds to a gaming feature on the mobile gaming platform 120, the cross-platform synching system 100 can enable gaming feature on the mobile gaming platform 120. For example, the cross-platform synching system 100 can enable the wild symbol on the gaming device 103, determine that the wild symbol on the gaming device 103 corresponds to a wild symbol feature on the mobile gaming platform 120, and enable the wild symbol on the mobile gaming platform 120.

The cross-platform synching system 100 can enable gaming features between any gaming platforms (e.g., a first gaming platform and a second gaming platform). The first gaming platform and the second gaming platform can include any gaming platform, including a gaming device, a casino gaming platform, a mobile gaming platform, a social gaming platform, and an online gaming platform. The first gaming platform and the second gaming platform can include different types of gaming platforms or the same type of gaming platforms.

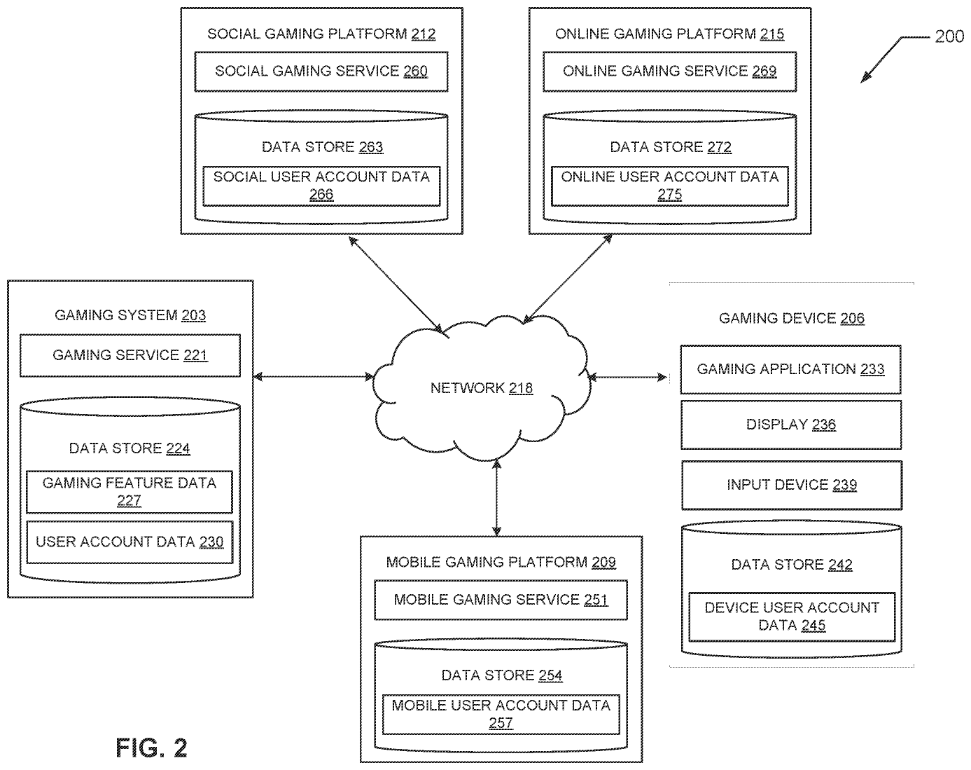

Referring now to FIG. 2, shown is an exemplary networked environment 200 for the cross-platform synching system according to various embodiments of the present disclosure. As will be understood and appreciated, the exemplary networked environment 200 shown in FIG. 2 represents merely one approach or embodiment of the present system, and other aspects are used according to various embodiments of the present system. Exemplary networked environment 200 can include, but is not limited to, the gaming system 203, the gaming device 206, the mobile gaming platform 209, the social gaming platform 212, and the online gaming platform 215 connected over a network 218.

The elements of the gaming system 203 can be provided via one or more computing devices that may be arranged, for example, in one or more server banks or computer banks or other arrangements. Such computing devices can be located in a single installation or may be distributed among many different geographical locations. For example, the gaming system 203 can include one or more computing devices that together may include a hosted computing resource, a grid computing resource, or any other distributed computing arrangement. In some cases, the gaming system 203 can correspond to an elastic computing resource where the allotted capacity of processing, network, storage, or other computing-related resources may vary over time. Regardless, the gaming system 203 can include one or more processors and memory having instructions stored thereon that, when executed by the one or more processors, cause the gaming system 203 to perform one, some, or all of the actions, methods, steps, or functionalities provided herein. As will be understood, the mobile gaming platform 209, the social gaming platform 212, and the online gaming platform 215 can be provided via one or more computing devices that together may include a hosted computing resource, a grid computing resource, or any other distributed computing arrangement similar to the gaming system 203. The mobile gaming platform 209, the social gaming platform 212, and the online gaming platform 215 include one or more processors and memory having instructions stored thereon that, when executed by the one or more processors, cause the mobile gaming platform 209, the social gaming platform 212, and/or the online gaming platform 215 to perform one, some, or all of the actions, methods, steps, or functionalities provided herein.

The gaming system 203 can include a gaming service 221 and the data store 224. The gaming service 221 can correspond to one or more software executables that can be executed by the gaming system 203 to perform the functionality described herein. Various data can be stored in the data store 224, including but not limited to, the gaming feature data 227 and user account data 230.

The gaming service 221 can communicate with multiple gaming devices 206, the mobile gaming platform 209, the social gaming platform 212, and the online gaming platform 215. In some embodiments, the gaming system 203 can include a casino management system that can communicate with multiple gaming devices 206 throughout the casino as well as the mobile gaming platform 209, the social gaming platform 212, and the online gaming platform 215. The gaming service 221 can receive and transmit messages and data with multiple gaming devices 206, the mobile gaming platform 209, the social gaming platform 212, and the online gaming platform 215. The gaming service 221 can authenticate user or patron account credentials from the multiple gaming devices 206, the mobile gaming platform 209, the social gaming platform 212, and the online gaming platform 215. The gaming service 221 can save the enabled gaming features associated with the user or patron accounts as the user account data 230. The gaming service 221 can transmit the gaming feature data 227 to the multiple gaming devices 206, the mobile gaming platform 209, the social gaming platform 212, and the online gaming platform 215 to determine if one gaming feature corresponds with another gaming feature.

According to various embodiments, the gaming device 206 can include any device capable of accessing network 218 including, but not limited to, a computer, smartphone, tablets, or other device. The gaming device 206 can be a gaming cabinet, an amusement device, a slot machine, or other gaming device with a processor-based system such as a computer system. The gaming device 206 can include a processor and a data store 242. The gaming device 206 can include a display 236 on which various user interfaces can be rendered to allow users to configure, monitor, control, and command various functions of the gaming application 233. The gaming device 206 can include the input device 239 for a user to provide various inputs (e.g., selections, wagers, credentials). The input device 239 can include one or more buttons, touch screens including three-dimensional or pressure-based touch screens, camera, finger print scanners, accelerometer, retinal scanner, gyroscope, magnetometer, or other input devices. The input device 239 can also include a bill acceptor, a player tracking module, a ticket printer, or some other device. The data store 224 can store data from the gaming device 206, including but not limited to the device user account data 245.

In various embodiments, gaming device 206 can include multiple computing devices. Regardless, the gaming device 206 can include one or more processors and memory having instructions stored thereon that, when executed by the one or more processors, cause the gaming device 206 to perform one, some, or all of the actions, methods, steps, or functionalities provided herein. The gaming device 206 can be configured to execute various applications, such as the gaming application 233 and/or other applications. The gaming application 233 may be executed by the gaming device 206, for example, to access network content served up by the gaming system 203, and/or other servers, thereby rendering various user interfaces on the display 236. While the specification discusses various functionality as being performed by the gaming application 233 or the gaming service 221, it is understood that this functionality may be performed by the gaming service 221, gaming application 233, or both in coordination.

The mobile gaming platform 209 can provide a platform for playing wagering games on mobile devices. The mobile gaming platform 209 can include the mobile gaming service 251 and the data store 254. The data store 254 can store the mobile user account data 257. The mobile device may execute a mobile app that provides the mobile wagering game. The mobile app may connect to the mobile gaming platform 209 to facilitate play of the wagering game on the mobile device. For example, the mobile app may receive player information associated with a user account. The mobile app may configure the game using the player information, such as, for example, enabling one or more gaming features based on the player information.

The social gaming platform 212 can provide a platform for playing wagering games on a social network. The social gaming platform 212 can include the social gaming service 260 and the data store 263. The data store 263 can store the social user account data 266.

The online gaming platform 215 can provide a platform for playing wagering games on an online browser (e.g., on a computing device, mobile device, tablet). The online gaming platform 215 can include the online gaming service 269 and the data store 272. The data store 272 can store the online user account data 275.

As will be understood, the gaming service 221, the gaming application 233, the mobile gaming service 251, the social gaming service 260, and the online gaming service 269 can be collectively referred to as gaming platforms (e.g., the first gaming platform and the second gaming platform). The gaming platforms can all have similar functionalities with respect to providing wagering games across different technologies. In one embodiment, one or more of the the gaming platforms may provide wagering using non-monetary tokens. The non-monetary tokens may be purchased using money, earned during play, earned from various activities, and/or given to a player. The non-monetary tokens may not be directly redeemable for money. The gaming platforms can generate outcomes for wagering game and increase or decrease the credits or tokens associated with the wagering game. A gaming platform can be considered a non-monetary gaming platform when the gaming platform provides wagering using non-monetary tokens (e.g., tokens not directly redeemable for money). The non-monetary gaming platform may include facilitating patrons to buy non-monetary gaming tokens for money. The gaming platforms can receive a request to cash out the credits or tokens associated with the wagering game. The gaming platforms can prompt the patron to provide credentials for a user or patron account associated with the gaming platform. The gaming application 233 can authenticate the user via a player tracking module, a radio frequency identifier (RFID) reader, a card reader, a near field communication (NFC), such as Bluetooth circuitry, Wi-Fi circuitry, or other wireless antenna-based technology. In some embodiments, the patron can insert a patron tracking card into the gaming device 206 to authenticate the patron account. In another embodiment, the gaming device 206 can read a user identifier associated with the patron from using near field communication (NFC). In some embodiments, the gaming platform can authenticate the credentials provided against the respective user account data for the gaming platform (e.g., the user account data 230, the device user account data 245, the mobile user account data 257, the social user account data 266, the online user account data 275). In some embodiments, the gaming platform can authenticate against an identity provider, such as a federated identity provider. In one embodiment, the identity provider can be used across one or more gaming platforms. In some embodiments, when a user is authenticated with the user or patron account, the gaming platform can associate the credits or tokens with the user account in response to a cash out event. In one embodiment, the gaming platform can print a ticket when a cashout event occurs. The gaming platform can transfer credits from a user or patron account to a gaming device 206. For example, when a patron authenticates a user account, the patron may request money be transferred from a patron account to the gaming device 206 via a player tracking input device 239.

The gaming platforms can prompt a user or patron to purchase a gaming feature or receive a request from the user or patron to enable a gaming feature for the particular gaming platform. The gaming platforms can prompt a user or patron to purchase a gaming feature or receive a request from the user or patron to enable a gaming feature for a combination of two or more gaming platforms. The gaming platforms can process a transaction to enable the gaming feature on the one or more gaming platforms. The gaming platform can process the transaction using the credits or tokens associated with the respective gaming platforms. The gaming platform can convert the credits or tokens from a different gaming platform. For example, a brick and mortar casino gaming platform can convert credits from a social media gaming platform to a special category of credits on a slot machine gaming device 206. The credits being transferred may be non-monetary tokens. The credits may be transferred to special category of credits, such as promotional credits, which may not be eligible for cashing out. The promotional credits can be used for playing the wagering game. In some embodiments, the promotional credits can be used to purchase gaming features. The special category of credits can be usable only for purchasing gaming features.

The gaming platform can determine that the particular gaming feature corresponds to a second gaming feature on a different gaming platform based on the gaming feature data 227. The particular game feature may be purchased on the gaming platform. After processing the transaction and enabling the particular gaming feature or currently while purchasing the particular gaming feature, the gaming platform can also enable the second gaming feature on a different gaming platform. For example, the first gaming platform can be the gaming service 203, which can determine that an enabled gaming feature corresponds to a gaming feature on the mobile gaming platform 209, the social gaming platform 212, and/or the online gaming platform 215.

The gaming platforms can enable one or more corresponding gaming features for a user or patron account associated with each respective gaming platform. The user or patron account can include the same account across one or more of the gaming platforms. The user or patron account can include different user or patron accounts that can be associated with one another based on a user or patron identification. In one embodiment, the patron can log in to a first patron account on a first gaming platform and request to link a second patron account on a second gaming platform. Upon successful authentication, the first patron account can be linked to the second patron account, such that future feature purchases on by either patron account can include a feature sync across to the other patron account as discussed herein.

The gaming platforms can establish communication and transmit requests to enable gaming features. The request can include metadata including a predetermined amount of time to enable the gaming features or a number of wagering games to enable the gaming features. After enabling the gaming features, one or more of the gaming platforms can determine that to perform an action based on one or more parameters corresponding to one or more of the game features. For example, a particular gaming feature on a particular gaming platform can be limited to a predetermined amount of time. As another example, the particular gaming feature can be limited to a predetermined number of wagering games. In response to the particular gaming platform determining that the predetermined amount of time has elapsed or that the predetermined number of wagering games have been played, the particular gaming platform can disable the gaming feature.

As one example, the gaming feature can correspond to an enhanced paytable. The enhanced pay table can increase an average payout of the wagering game. For example, if the wagering game currently has an average payout of 96% of coin in, the gaming feature can utilize an enhanced pay table with an average payout of 102%. The enhanced paytable can be limited to a number of games. In one embodiment, the enhanced paytable can include a value associated with the additional payout. The value of the additional payout can be equal to a bet amount times an increase in the average payout times a number of games that the enhanced paytable is available. For example, a game feature that provides a 6% increased paytable to a $1 max bet game for 100 games may have a value of $6.00. In some embodiments, non-monetary tokens from a first gaming platform can be used to purchase an enhanced paytable gaming feature on a monetary game. In some embodiments, the enhanced paytable gaming feature can be different on different platforms. For example, the a social gaming platform 212 can enable a 200% enhanced paytable gaming feature for non-monetary tokens, while an online gaming platform 215 can enable a corresponding 105% enhanced paytable gaming feature for monetary gaming credits. The cost in non-monetary tokens can be a value of the non-monetary tokens equal to the value of the additional payout of the monetary wagering game. As an example, the social gaming service 260 can receive a request to buy an enhanced paytable gaming feature on from the gaming application 233 for a particular number of games. The social gaming service 260 can enable the enhanced paytable gaming feature in the social user account data 266 for the particular number of games. The social gaming service 260 can transmit a request to the online gaming service 269 (or other gaming service as can be appreciated) to enable an enhanced paytable gaming feature in the online user account data 275 for the particular number of games (or a different number of games per configuration of the online gaming platform 215). The online gaming service 269 can receive the request. The online gaming service 269 can authenticate a digital signature associated with the social gaming platform 212 embedded within the request. The online gaming service 269 enable the gaming feature in the online user account data 275.

As another example, the gaming feature can correspond to a particular themed skin for the gaming device. As an example, the themed skin can correspond to a flaming version of the indicia in the game, a freezing version of the indicia, a bright version of the indicia, or a shadowy version of the indicia. The first themed skin gaming feature on a first gaming platform may differ from a corresponding second themed skin gaming feature on a second gaming platform. For example, the first themed skin gaming feature may be limited to a reduced resolution based on the resolution of the display 236, while the second themed skin gaming feature may have a different resolution corresponding to a different display (e.g., a user's home computer for an online gaming platform 215). As another example, the gaming feature can include embedding a custom image as an indicia into the wagering game. The custom image can correspond to a photo of the patron.

As yet another example, the gaming feature can correspond to a jackpot award. For example, the gaming feature can cause the wagering game to be enrolled in one or more levels of a jackpot, such as a progressive jackpot. A first gaming feature cause the wagering game to be enrolled in the one or more levels of a jackpot on the first gaming platform, while a corresponding second gaming feature on a second gaming platform can cause enrollment in one or more levels of a different jackpot on the second gaming platform.

The network 218 can include, for example, the Internet, intranets, extranets, wide area networks (WANs), local area networks (LANs), wired networks, wireless networks, or other suitable networks, etc., or any combination of two or more such networks.

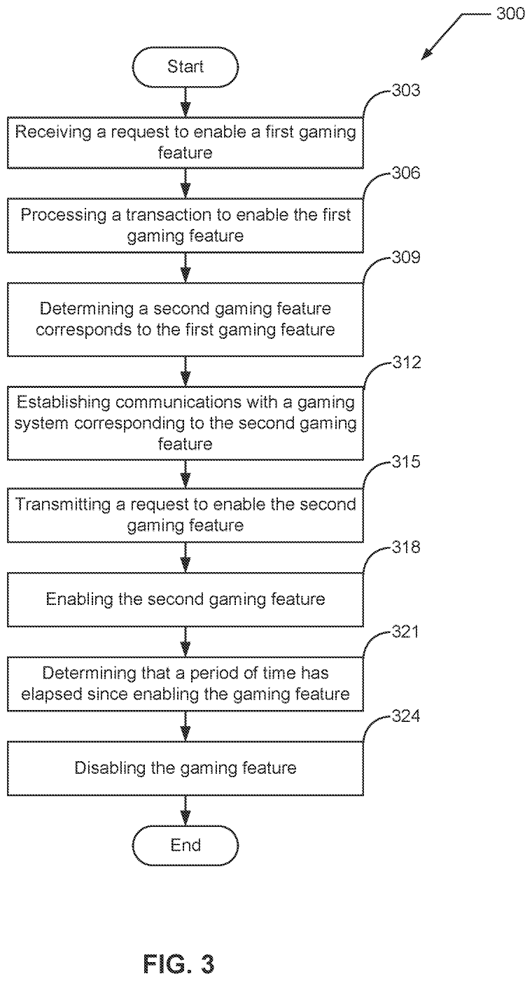

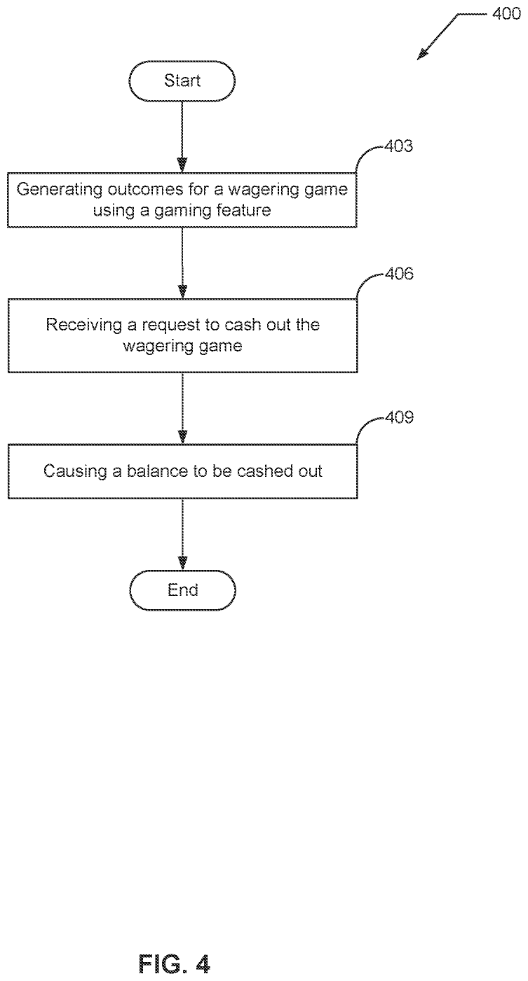

Referring now to FIG. 3, shown is an exemplary, high-level overview process 300 according to various embodiments of the present disclosure. As will be understood by one having ordinary skill in the art, the steps and processes shown in FIGS. 3 and 4 may operate concurrently and continuously, are generally asynchronous and independent, can be performed in part or in whole by a combination of one or more of the gaming device 206, the gaming system 203, the mobile gaming platform 209, the social gaming platform 212, and the online gaming platform 215, and are not necessarily performed in the order shown and various steps can be executed linearly or in parallel. Process 300 can be performed entirely, partially, or in coordination with the gaming service 221, the gaming application 233, the mobile gaming service 251, the social gaming service 260, and the online gaming service 269.

At step 303, the process 300 can include receiving a request to enable a first gaming feature. The gaming service 221, the gaming application 233, the mobile gaming service 251, the social gaming service 260, or the online gaming service 269 can receive the request depending on the type of wagering game being played (e.g., a wagering game on a gaming device, casino gaming, mobile gaming, social gaming, online gaming). For example, if the wagering game is being played on a gaming device 203, the gaming application 233 or the gaming service 221 can receive the request to enable the first gaming feature. The gaming application 233 can receive the request via a touch screen input device 239 and transmit the request to the gaming service 221 for processing. As another example, if the wagering game is being played on the mobile gaming platform 209, the mobile gaming service 251 can receive the request to enable the first gaming feature. As another example, if the wagering game is being played on the social gaming platform 212, the social gaming service 260 can receive the request to enable the first gaming feature. As another example, if the wagering game is being played on the online gaming platform 215, the online gaming service 269 can receive the request to enable the first gaming feature. As will be understood, the gaming service 221, the gaming application 233, the mobile gaming service 251, the social gaming service 260, or the online gaming service 269 can be collectively or individually referred to as the first gaming platform. In some embodiments, the request to enable the first gaming feature can be a request to enable more than one gaming feature across multiple gaming platforms. For example, the user interface facilitating buying the gaming feature can specify on which platforms the gaming feature will be enabled if purchased.

The request can be associated with a patron or user account. For example, the first gaming platform can authenticate the user or patron playing the game prior to, during, or after receiving the request to enable the first gaming feature. The first gaming platform can prompt the patron or user to provide credentials for the patron or user account. If the wagering game is being played on a gaming device 206, the gaming application 233 can authenticate the user via a player tracking module, a radio frequency identifier (RFID) reader, a card reader, a near field communication (NFC), such as Bluetooth circuitry, Wi-Fi circuitry, or other wireless antenna-based technology. In some embodiments, the patron can insert a patron tracking card into the gaming device 206 to authenticate the patron account. In another embodiment, the gaming device 206 can read a user identifier associated with the patron from using near field communication (NFC). The type of patron or user account can depend on the type of wagering game being played (e.g., a device user account, gaming system user account, a casino system user account, a mobile user account, a social user account, an online user account). The game features can include, but are not limited to, a set of graphics, a wild symbol, a bonus game, a payback feature, an upgraded pay table, nudging attempts, a visual skin, a game of skill, assigning the wagering game to a particular level of a progressive jackpot, eligibility to win a progressive jackpot, and a previously-unavailable game.

At step 306, the process 300 can include processing a transaction to enable the first gaming feature. The first gaming platform (e.g., the gaming service 221, the gaming application 233, the mobile gaming service 251, the social gaming service 260, the online gaming service 269) can process the transaction to enable the first gaming feature. The transaction can be processed using credits or tokens from the wagering game being played. As will be understood, the tokens can represent or be converted to a certain number of credits or to a currency (e.g., dollars). Each gaming feature can require a certain number of credits or tokens to be enabled. For example, if the patron or user account has a sufficient number of credits or tokens to enable the gaming feature, the transaction can be completed and the gaming feature can be enabled. As another example, if the patron or user account has an insufficient number of credits or tokens to enable the gaming feature, the transaction can be denied.

In some embodiments, the gaming platform may limit a number of credits to be cashed out. For example the gaming platform may prevent a patron from cashing out less than $5 in credits from the wagering game. If below the threshold, the patron may either play off the remaining credits or leave them on the gaming device and walk away. In some embodiments, the gaming platform can enable the patron to purchase one or more gaming features using the remaining credits. The gaming platform can determine a value of the remaining gaming credits and present generate a list of one or more gaming features at or below that value. The gaming features can be valued based on a cost of the gaming features across one or more gaming platforms. In one embodiment, the gaming platform can generate an enhanced paytable gaming feature at a cost equal to the remaining gaming credits. The gaming platform can calculate the cost as a value associated with the additional payout of the gaming feature across one or more gaming platforms. In one embodiment, the gaming platform can determine the cost as a value associated with the additional payout of the gaming feature on a monetary wagering gaming platform. A monetary gaming platform may enable an enhanced paytable feature on a non-monetary gaming platform and the monetary gaming platform at the cost equal to the value associated with the additional payout of the gaming feature on a monetary wagering gaming platform. For example, the gaming platform may give the non-monetary gaming feature as a free bonus for buying the monetary gaming feature.

The transaction can be processed using credits or tokens from a second gaming platform. For example, if the wagering game is being played on the gaming device 206, the transaction can be processed using credits or tokens associated with the gaming system 203, the mobile gaming platform 209, the social gaming platform 212, or the online gaming platform 215. As another example, if the wagering game is being played on the gaming system 203, the transaction can be processed using credits or tokens associated with the gaming device 206, the mobile gaming platform 209, the social gaming platform 212, or the online gaming platform 215. As another example, if the wagering game is being played on the mobile gaming platform 209, the transaction can be processed using credits or tokens associated with the gaming system 203, the gaming device 206, the social gaming platform 212, or the online gaming platform 215. As another example, if the wagering game is being played on the social gaming platform 212, the transaction can be processed using credits or tokens associated with the gaming system 203, the gaming device 206, the mobile gaming platform 209, or the online gaming platform 215. As another example, if the wagering game is being played on the online gaming platform 215, the transaction can be processed using credits or tokens associated with the gaming system 203, the gaming device 206, the mobile gaming platform 209, or the social gaming platform 212. As will be understood, the different types of gaming platforms (e.g., the gaming service 221, the gaming application 233, the mobile gaming service 251, the social gaming service 260, or the online gaming service 269) can be collectively referred to as the first gaming platform or the second gaming platform and the first gaming platform and the second gaming platform can be different (e.g., both the first gaming platform and the second gaming platform may not be the same type of gaming platform). In some embodiments, the first gaming platform and the second gaming platform can include the same type of gaming platform.

If the first gaming platform is processing the transaction using credits or tokens associated with the second gaming platform, the first gaming platform or the second gaming platform can convert the credits or tokens associated with the second gaming platform into credits or tokens associated with the first gaming platform. The converted credits or tokens can be transferred from a patron or user account associated with the second gaming platform to a patron or user account associated with the first gaming platform. In some embodiments, the patron or user account associated with the first gaming platform can be the same patron or user account associated with the second gaming platform. The converted credits or tokens can be won or received during a wagering game on the second gaming platform. The tokens from either the first gaming platform or the second gaming platform can be cashable tokens (e.g., tokens that can be redeemed for cash or credits) or non-cashable tokens. In some embodiments, the credits or tokens from the second gaming platform can be used to process the transaction by the first gaming platform without first being converted (e.g., the credits or tokens from the second gaming platform can be the same type of credits or tokens as the first gaming platform).

At step 309, the process 300 can include determining that a second gaming feature corresponds to the first gaming feature. The first gaming platform (e.g., the gaming service 221, the gaming application 233, the mobile gaming service 251, the social gaming service 260, the online gaming service 269) can determine that a second gaming feature corresponds to the first gaming feature. The second gaming feature can be the same type or different type of gaming feature as the first gaming feature. The first gaming feature can correspond to a respective second gaming feature on the second gaming platform. For example, if the first gaming feature is a bonus game, the first gaming feature can correspond to a second gaming feature, which can be a bonus game on the second gaming platform. The first gaming platform can determine that the first gaming feature corresponds to a second gaming feature based on the gaming feature data 227. For example, the gaming application 233, the mobile gaming service 251, the social gaming service 260, or the online gaming service 269 can request the gaming feature data 227 from the gaming system 203 to determine if the first gaming feature corresponds to a second gaming feature.

At step 312, the process 300 can include establishing communications between the first gaming platform and the second gaming platform. The first gaming platform (e.g., the gaming service 221, the gaming application 233, the mobile gaming service 251, the social gaming service 260, the online gaming service 269) can establish communication with the second gaming platform. The second gaming platform can depend on the type of gaming feature or wagering game. For example, if the first gaming platform determines that the first gaming feature corresponds to a second gaming feature on the mobile gaming platform 209, the second gaming platform can be the mobile gaming platform 209. The first gaming platform can transmit a request to the second gaming platform to establish communications and the second gaming platform can accept or reject the request to establish communications. Depending on whether the second gaming platform accepts or rejects the request, the second gaming platform can transmit a success or failure message to the first gaming platform. In some embodiments, communications between the first gaming platform and the second gaming platform can be established via the gaming system 203. For example, the first gaming platform can include the gaming device 206. The gaming system 203 can include a casino management system with multiple gaming devices 206 and a mobile gaming platform 209. In this example, communication between the gaming device 206 and the mobile gaming platform 209 can be established via the gaming system 203 (e.g., the casino management system).

At step 315, the process 300 can include transmitting a request to enable the second gaming feature on the second gaming platform. The first gaming platform (e.g., the gaming service 221, the gaming application 233, the mobile gaming service 251, the social gaming service 260, the online gaming service 269) can transmit a request to enable the second gaming feature on the second gaming platform. The request can include metadata related to the first gaming feature or the second gaming feature. For example, the metadata can include a number of games to enable the second gaming feature (e.g., 1 game, 2 games, 5 games, 10 games, 100 games). At step 318, the second gaming feature can be enabled. The second gaming platform (e.g., the gaming service 221, the gaming application 233, the mobile gaming service 251, the social gaming service 260, the online gaming service 269) can enable the second gaming feature. After enabling the second gaming feature, the second gaming platform can send a success message to the first gaming platform.

At step 321, the process 300 can include determining that a period of time has elapsed since enabling the first gaming feature or the second gaming feature. The first gaming platform or the second gaming platform (e.g., the gaming service 221, the gaming application 233, the mobile gaming service 251, the social gaming service 260, the online gaming service 269) can determine that a period of time has elapsed since the first gaming feature or the second gaming feature was enabled. The period of time can be predetermined based on the gaming feature data 227, the type of gaming feature, or type of wagering game. In some embodiments, the first gaming platform or the second gaming platform can determine that a predetermined number of games have been played. At step 324, the process 300 can include disabling the first gaming feature or the second gaming feature. The first gaming platform or the second gaming platform (e.g., the gaming service 221, the gaming application 233, the mobile gaming service 251, the social gaming service 260, the online gaming service 269) can disable the first gaming feature or the second gaming feature based on the determination that the period of time has elapsed or the predetermined number of games has been played.

Referring now to FIG. 4, shown is an exemplary process 400 for playing a wagering game according to various embodiments of the present disclosure. As will be understood, the process 400 can operate before, during, or after any of the steps in the process 300. Process 400 can be performed entirely, partially, or in coordination with the gaming device 206, the gaming system 203, the mobile gaming platform 209, the social gaming platform 212, and the online gaming platform 215. At step 403, the process 400 can generating an outcome for a wagering game. The first gaming platform or second gaming platform (e.g., the gaming service 221, the gaming application 233, the mobile gaming service 251, the social gaming service 260, the online gaming service 269) can generate an outcome for a wagering game. The outcome can be a winning outcome or a losing outcome. For example, if the outcome is a winning outcome, the patron or user can receive credits or tokens based on the winning outcome. As another example, if the outcome is a losing outcome, the patron or user can lose credits or tokens based on the losing outcome.

The outcome can be generated using an enabled gaming feature. For example, if the enabled gaming feature is a bonus game, the outcome can be generated by playing the bonus. If multiple gaming features are enabled, the outcome can be generated using one or more of the enabled gaming features. If the gaming feature is enabled on the first gaming platform, the outcome can be generated by playing the wagering game on the first gaming platform. If the gaming feature is enabled on the second gaming platform, the outcome can be generated by playing the wagering game on the second gaming platform. In some embodiments, multiple outcomes can be generated if multiple gaming features are enabled.

At step 406, the process 400 can include receiving a request to cash out the wagering game. The first gaming platform or the second gaming platform can receive a request to cash out the wagering game. The request can be initiated by input from a user or patron. The request to cash out can include a request to cash out the credits or tokens associated with the wagering game being played on the first gaming platform or the second gaming platform. At step 409, the process 400 can include causing a balance to be cashed out. The first gaming platform or the second gaming platform can cause the balance to be cashed out. Causing the balance to be cashed out can include printing a ticket for the patron or user, providing a code (e.g., a QR code, a balance code) for the patron or user to redeem, providing cash to the patron or user at a teller, or providing a balance to a patron or user account for the patron or user to redeem for a wagering game or with a payment service.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include non-transitory computer-readable media for carrying or having computer-executable instructions or data structures stored thereon. Such computer-readable media can be any available media which can be accessed by a computer, or downloadable through communication networks. By way of example, and not limitation, such computer-readable media can include various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions include, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The processing unit can include one or more hardware processors. The computer will typically include one or more data storage devices for reading data from and writing data to. The data storage devices provide nonvolatile storage of computer-executable instructions, data structures, program modules, and other data for the computer.

Computer program code that implements the functionality described herein typically includes one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LAN (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In some embodiments, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein. While thresholds are discussed herein as being met when the threshold is exceeded, the system may determine a threshold is met when a value meets or exceeds the threshold.

Clause 1. A system, comprising: a data store configured to store a plurality of user accounts; and at least one computing device in communication with the data store, the at least one computing device being configured to at least: receive a request to enable a first gaming feature for a particular wagering game on a particular gaming device of a plurality of gaming devices associated with a first type of wagering game, the request being associated with a first patron account; process a transaction to enable the first gaming feature for the first patron account; determine a second gaming feature for a second type of wagering game that corresponds to the first gaming feature; and cause the second gaming feature to be enabled on a second patron account associated with the first patron account based on the transaction.

Clause 2. The system of clause 1 or any other clause herein, wherein the first type and the second type respectively comprises a different one of: casino gaming, mobile gaming, social gaming, and online gaming.

Clause 3. The system of clause 1 or any other clause herein, wherein the at least one computing device is further configured to: determine that a particular period of time has elapsed since the first gaming feature was enabled for the first patron account; and in response to the particular period of time elapsing, disable the first gaming feature for the first patron account.

Clause 4. The system of clause 1 or any other clause herein, wherein the first gaming feature comprises enabling a set of graphics on the particular wagering game.

Clause 5. The system of clause 1 or any other clause herein, wherein the at least one computing device is further configured to: determine that a particular period of time has elapsed since the second gaming feature was enabled for the second patron account; and in response to the particular period of time elapsing, cause the second gaming feature to be disabled for the second patron account.

Clause 6. The system of clause 1 or any other clause herein, wherein the at least one computing device is further configured to process the transaction using credits from the particular wagering game.

Clause 7. A method, comprising: receiving, via one of one or more computing devices, a request to enable a first gaming feature for a particular wagering game on a particular gaming device of a plurality of gaming devices associated with a first type of wagering game, the request being associated with a first patron account; processing, via one of the one or more computing devices, a transaction to enable the first gaming feature for the first patron account; determining, via one of the one or more computing devices, a second gaming feature for a second type of wagering game that corresponds to the first gaming feature; and causing, via one of the one or more computing devices, the second gaming feature to be enabled on a second patron account associated with the first patron account based on the transaction.

Clause 8. The method of clause 7 or any other clause herein, further comprising converting, via one of the one or more computing devices, a plurality of game tokens of the first type to the second type.

Clause 9. The method of clause 8 or any other clause herein, wherein game tokens of the first type are non-cashable tokens and game tokens of the second type are cashable tokens.

Clause 10. The method of clause 8 or any other clause herein, further comprising processing, via one of the one or more computing devices, the transaction using credits from a second particular wagering game corresponding to the second type of wagering game.

Clause 11. The method of clause 8 or any other clause herein, further comprising: receiving, via one of the one or more computing devices, a request to cash out the game tokens of the second type; and causing, via one of the one or more computing devices, a balance of the second type of game tokens to be paid to a patron.

Clause 12. The method of clause 8 or any other clause herein, wherein the first gaming feature comprises enabling eligibility to win a progressive jackpot on the particular wagering game.

Clause 13. A non-transitory computer-readable medium embodying a program that, when executed by at least one computing device, causes the at least one computing device to: receive a request to enable a first gaming feature for a particular wagering game on a particular gaming device of a plurality of gaming devices associated with a first type of wagering game, the request being associated with a first patron account; process a transaction to enable the first gaming feature for the first patron account; determine a second gaming feature for a second type of wagering game that corresponds to the first gaming feature; and cause the second gaming feature to be enabled on a second patron account associated with the first patron account based on the transaction.

Clause 14. The non-transitory computer-readable medium of clause 13 or any other clause herein, wherein a first plurality of gaming features of the first type of wagering game individually correspond to a respective one of a second plurality of gaming features of the second type of wagering game, wherein the first plurality of gaming features comprises the first gaming feature and the second plurality of gaming features comprises the second gaming feature.

Clause 15. The non-transitory computer-readable medium of clause 13 or any other clause herein, wherein the program further causes the at least one computing device to generate a plurality of outcomes of the particular wagering game based on the first gaming feature.

Clause 16. The non-transitory computer-readable medium of clause 13 or any other clause herein, wherein the program further causes the at least one computing device to cause a second gaming system corresponding to the second type of wagering games to utilize the second gaming feature to generate a plurality of outcomes.

Clause 17. The non-transitory computer-readable medium of clause 13 or any other clause herein, wherein the program further causes the at least one computing device to cause the second gaming feature to be enabled by: determining the second gaming feature corresponds to the first gaming feature; establishing communications with a gaming system corresponding to the second type of wagering game; and transmitting a request to enable the second gaming feature on the gaming system.

Clause 18. The non-transitory computer-readable medium of clause 17 or any other clause herein, wherein the request to enable the second gaming feature comprises metadata comprising a number of games to enable the gaming feature.

Clause 19. The non-transitory computer-readable medium of clause 13 or any other clause herein, wherein the first gaming feature comprises enabling a bonus game on the particular wagering game.

Clause 20. The non-transitory computer-readable medium of clause 13 or any other clause herein, wherein the first gaming feature comprises enabling a wild on the particular wagering game.

These and other aspects, features, clauses, and benefits of the claims will become apparent from the detailed written description of the aforementioned aspects taken in conjunction with the accompanying drawings, although variations and modifications thereto may be effected without departing from the spirit and scope of the novel concepts of the disclosure.

What is claimed is:

1. A system, comprising:
a data store configured to store a plurality of user accounts; and
at least one computing device in communication with the data store, the at least one computing device being configured to at least:
receive a request to enable a first gaming feature for a particular wagering game on a particular gaming device of a plurality of gaming devices associated with a first type of wagering game, the request being associated with a first patron account;
process a transaction to enable the first gaming feature for the first patron account;
determine a second gaming feature for a second type of wagering game that corresponds to the first gaming feature; and
cause the second gaming feature to be enabled on a second patron account associated with the first patron account based on the transaction.

2. The system of claim 1, wherein the first type and the second type respectively comprises a different one of: casino gaming, mobile gaming, social gaming, and online gaming.

3. The system of claim 1, wherein the at least one computing device is further configured to:
determine that a particular period of time has elapsed since the first gaming feature was enabled for the first patron account; and
in response to the particular period of time elapsing, disable the first gaming feature for the first patron account.

4. The system of claim 1, wherein the first gaming feature comprises enabling a set of graphics on the particular wagering game.

5. The system of claim 1, wherein the at least one computing device is further configured to:
determine that a particular period of time has elapsed since the second gaming feature was enabled for the second patron account; and
in response to the particular period of time elapsing, cause the second gaming feature to be disabled for the second patron account.

6. The system of claim 1, wherein the at least one computing device is further configured to process the transaction using credits from the particular wagering game.

7. A method, comprising:
receiving, via one of one or more computing devices, a request to enable a first gaming feature for a particular wagering game on a particular gaming device of a plurality of gaming devices associated with a first type of wagering game, the request being associated with a first patron account;
processing, via one of the one or more computing devices, a transaction to enable the first gaming feature for the first patron account;
determining, via one of the one or more computing devices, a second gaming feature for a second type of wagering game that corresponds to the first gaming feature; and
causing, via one of the one or more computing devices, the second gaming feature to be enabled on a second patron account associated with the first patron account based on the transaction.

8. The method of claim 7, further comprising converting, via one of the one or more computing devices, a plurality of game tokens of the first type to the second type.

9. The method of claim 8, wherein game tokens of the first type are non-cashable tokens and game tokens of the second type are cashable tokens.

10. The method of claim 8, further comprising processing, via one of the one or more computing devices, the transaction using credits from a second particular wagering game corresponding to the second type of wagering game.

11. The method of claim 8, further comprising:
receiving, via one of the one or more computing devices, a request to cash out the game tokens of the second type; and
causing, via one of the one or more computing devices, a balance of the second type of game tokens to be paid to a patron.

12. The method of claim 8, wherein the first gaming feature comprises enabling eligibility to win a progressive jackpot on the particular wagering game.

13. A non-transitory computer-readable medium embodying a program that, when executed by at least one computing device, causes the at least one computing device to:
receive a request to enable a first gaming feature for a particular wagering game on a particular gaming device of a plurality of gaming devices associated with a first type of wagering game, the request being associated with a first patron account;
process a transaction to enable the first gaming feature for the first patron account;
determine a second gaming feature for a second type of wagering game that corresponds to the first gaming feature; and
cause the second gaming feature to be enabled on a second patron account associated with the first patron account based on the transaction.

14. The non-transitory computer-readable medium of claim 13, wherein a first plurality of gaming features of the first type of wagering game individually correspond to a respective one of a second plurality of gaming features of the second type of wagering game, wherein the first plurality of gaming features comprises the first gaming feature and the second plurality of gaming features comprises the second gaming feature.

15. The non-transitory computer-readable medium of claim 13, wherein the program further causes the at least one computing device to generate a plurality of outcomes of the particular wagering game based on the first gaming feature.

16. The non-transitory computer-readable medium of claim 13, wherein the program further causes the at least one computing device to cause a second gaming system corresponding to the second type of wagering games to utilize the second gaming feature to generate a plurality of outcomes.

17. The non-transitory computer-readable medium of claim 13, wherein the program further causes the at least one computing device to cause the second gaming feature to be enabled by:
determining the second gaming feature corresponds to the first gaming feature;
establishing communications with a gaming system corresponding to the second type of wagering game; and
transmitting a request to enable the second gaming feature on the gaming system.

18. The non-transitory computer-readable medium of claim 17, wherein the request to enable the second gaming feature comprises metadata comprising a number of games to enable the gaming feature.

19. The non-transitory computer-readable medium of claim 13, wherein the first gaming feature comprises enabling a bonus game on the particular wagering game.

20. The non-transitory computer-readable medium of claim 13, wherein the first gaming feature comprises enabling a wild on the particular wagering game.
